(19) United States
(12) Patent Application Publication
(10) Pub. No.: US 2022/0363125 A1
(43) Pub. Date: Nov. 17, 2022

(54) VEHICLE HEAT EXCHANGE APPARATUS

(71) Applicant: HONDA MOTOR CO., LTD., Tokyo (JP)

(72) Inventors: Takuro Tominaga, Tokyo (JP); Takuya Fujikawa, Tokyo (JP)

(21) Appl. No.: 17/659,494

(22) Filed: Apr. 18, 2022

(30) Foreign Application Priority Data
May 17, 2021 (CN) 202110535555.6

(51) Int. Cl. B60K 11/04; F01P 11/10

(52) U.S. Cl. CPC B60K 11/04; F01P 11/10

(57) ABSTRACT

Provided is a vehicle heat exchange apparatus having a structure that allows a gap between a radiator and another heat exchanger disposed side by side therein to be closed in a simple and stable manner even it the radiator and the heat exchanger are largely spaced from each other. A vehicle heat exchange apparatus according to an embodiment of the present invention includes a radiator, a heat exchanger, air barrier walls, and closure members. The radiator has a core and tanks provided on left and right sides of the core. The heat exchanger is disposed side by side with the radiator in a front-back direction of a vehicle. The air barrier walls are provided on the respective tanks and extend toward the heat exchanger while leaving a gap between the air barrier walls and the heat exchanger. The closure members each close at least a portion of the gap.

This application is based on and claims the benefit of priority from Chinese Patent Application No. CN202110535555.6, filed on 17 May 2021, the content of which is incorporated herein by reference.

### BACKGROUND OF THE INVENTION

### Field of the Invention

The present invention relates to a vehicle heat exchange apparatus.

### Related Art

A vehicle usually has, in a front compartment in a front portion thereof, a radiator that cools cooling water for an engine and a condenser that cools a refrigerant of an air conditioner. The radiator and the condenser are usually arranged side by side in a front-back direction, and the cooling efficiency thereof is increased by utilizing traveling air introduced through an opening in the front of the vehicle. However, the radiator and the condenser are spaced from each other as shown in FIG. 6, and the traveling air escapes through a gap therebetween after passing through the radiator located frontward of the condenser as indicated by two-dot chain lines in FIG. 6. As a result, only a reduced amount of traveling air comes in contact with the condenser located behind the radiator, and thus the cooling efficiency decreases. Note that the cooling efficiency of the radiator and the condenser further decreases when the vehicle is stopped or running at low speed, because heat emitted from a heat generating element such as the engine comes into the space between the radiator and the condenser through the gap.

One technique to solve such problems is by providing a seal packing between the radiator and the condenser as shown in FIGS. 10 and 11 of Japanese Unexamined Patent Application, Publication No. 2004-197636.

Patent Document 1: Japanese Unexamined Patent Application, Publication No. 2004-197636

### SUMMARY OF THE INVENTION

However, in a case where the radiator and the condenser are largely spaced from each other, it is difficult to provide the seal packing for closing the gap between the radiator and the condenser in a stable manner. In order to provide the seal packing, therefore, it is necessary to produce and assemble, on a per-vehicie type basis, a dedicated seal packing mounting part. As a result, not only does the vehicle cost increase, but assembly man-hours increase.

An object of the present invention is to provide a vehicle heat exchange apparatus having a structure that allows a gap between a radiator and another heat exchanger disposed side by side therein to be closed in a simple and stable manner even if the radiator and the heat exchanger are largely spaced from each other.

(1) The present invention provides a vehicle heat exchange apparatus including: a radiator having a core and tanks provided on left and right sides of the core; a heat exchanger disposed side by side with the radiator in a front-back direction of a vehicle; air barrier walls provided on the respective tanks, the air barrier walls extending toward the heat exchanger while leaving a gap between the air barrier walls and the heat exchanger; and closure members each closing at least a portion of the gap.

(2) In the vehicle heat exchange apparatus according to (1), preferably, each of the air barrier walls has a longitudinal wall section extending toward the heat exchanger, a lateral wall section extending from a heat exchanger-facing end of the longitudinal wall section toward a neighboring one of the sides of the vehicle, and a second longitudinal wall section extending from a vehicle's side-facing end of the lateral wall section toward the heat exchanger, and the closure members are provided on the respective air barrier walls and are each arranged along an inner side of a corner formed by the corresponding lateral wall section and the corresponding second longitudinal wall section.

(3) In the vehicle heat exchange apparatus according to (2), preferably, cross sections of the longitudinal wall section and the lateral wall section of each air barrier wall form an approximate L-shape, and the air barrier wall is provided with a rib inside the L-shape.

(4) In the vehicle heat exchange apparatus according to any one of (1) to (3), preferably, the heat exchanger is a condenser having at least one condenser tank at a side end of the condenser, the condenser is located behind the radiator in the vehicle, and the condenser tank is located further toward a neighboring one of the sides of the vehicle than a neighboring one of the air barrier walls.

(5) In the vehicle heat exchange apparatus according to any one of (1) to (4), preferably, each of the air barrier walls on the tanks is provided on a side toward the middle of the vehicle in a left-right direction of the vehicle and extends from an upper end to a lower end of the corresponding tank.

According to the present invention, the air barrier walls extending toward the heat exchanger are provided on the respective tanks of the radiator, making it possible to close the gap between the radiator and the heat exchanger in a simple and stable manner even if the radiator and the heat exchanger are largely spaced from each other. The present invention therefore allows for an increased cooling efficiency while eliminating the need to provide dedicated mounting parts for mounting the closure members, and thus reducing assembly man-hours.

### BRIEF DESCRIPTION OF THE DRAWINGS

FIG. 1 is a plan view schematically illustrating a configuration of a vehicle having a vehicle heat exchange apparatus according to an embodiment of the present invention;

FIG. 2 is a schematic enlarged view of a right end portion of the vehicle heat exchange apparatus shown in FIG. 1;

FIG. 3 is a right side view of the vehicle heat exchange apparatus observed in a direction A shown in FIG. 2;

FIG. 4 is a schematic enlarged view of a left end portion of the vehicle heat exchange apparatus shown in FIG. 1;

FIG. 5 is a plan view schematically illustrating a modification example of the embodiment, of the present invention; and

FIG. 6 is a schematic diagram for explaining problems of a conventional vehicle heat exchange apparatus.

### DETAILED DESCRIPTION OF THE INVENTION

The following describes an embodiment of the present invention in detail with reference to the accompanying drawings.

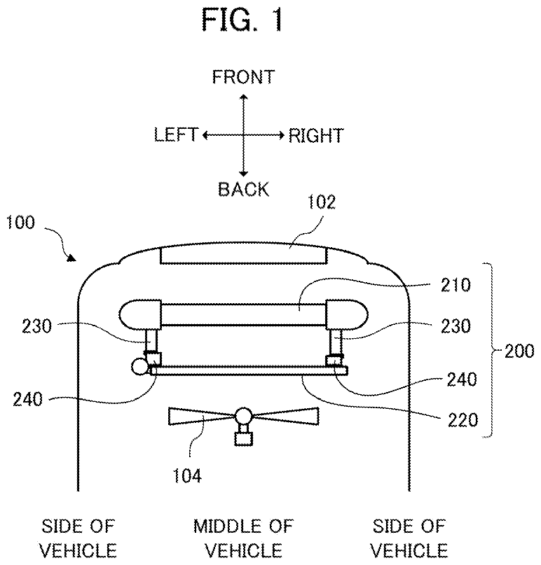

FIG. 1 is a plan view schematically illustrating a configuration of a vehicle having a vehicle heat exchange apparatus according to an embodiment of the present invention. A vehicle heat exchange apparatus 200 is provided in a front compartment in a front portion of a vehicle 100. A front end of the vehicle 100 has an opening 102 for introducing traveling air. The vehicle heat exchange apparatus 200 can be cooled by utilizing traveling air introduced through the opening 102 while the vehicle 100 is traveling.

A fan 104 is provided behind the vehicle heat exchange apparatus 200. No traveling air or only a weak stream of traveling air is introduced when the vehicle 100 is stopped or running at low speed. The fan 104 is then activated to forcibly draw air through the opening 102 to cool the vehicle heat exchange apparatus 200.

The vehicle heat exchange apparatus 200 includes a radiator 210, a condenser 220, air barrier walls 230, and closure members 240. The condenser 220 is a type of heat exchanger. The condenser 220 is disposed side by side with the radiator 210 in a front-back direction of the vehicle 100. In the present embodiment, the condenser 220 is located behind the radiator 210.

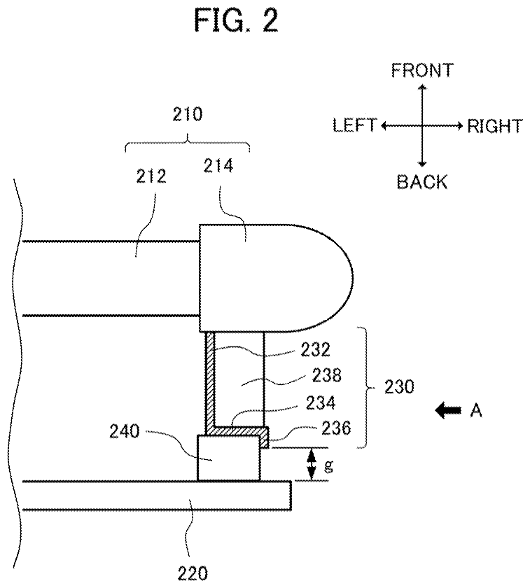

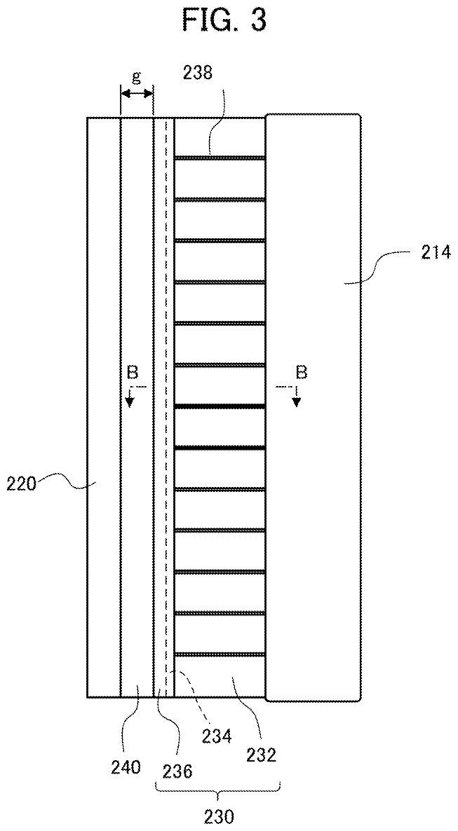

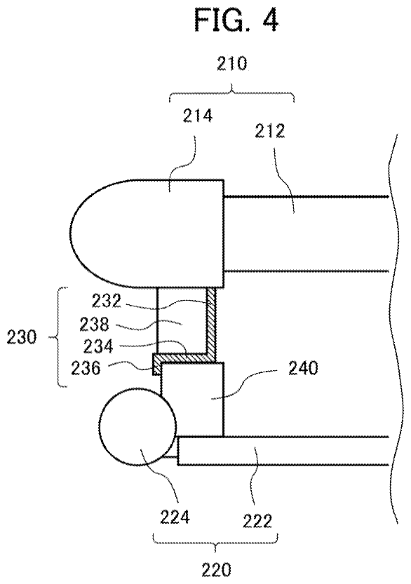

FIG. 2 is a schematic enlarged view of a right end portion of the vehicle heat exchange apparatus shown in FIG. 1. FIG. 3 is a right side view of the vehicle heat exchange apparatus observed in a direction A shown in FIG. 2. FIG. 4 is a schematic enlarged view of a left end portion of the vehicle heat exchange apparatus shown in FIG. 1.

The radiator 210 cools cooling water for an engine for the travel of the vehicle. As shown in the drawings, the radiator 210 has a core 212 and tanks 214.

The core 212 has a plurality of radiator tubes and a plurality of fins, not shown. The radiator tubes function as paths for the cooling water and transfer heat to the fins. The radiator tubes themselves also dissipate heat. The fins receive heat transferred from the radiator tubes and dissipate the heat into the air. The fins also have a function of reinforcing the radiator tubes.

The tanks 214 are provided on left and right sides of the core 212, and are in communication with the radiator tubes. The tanks 214 have a function of temporarily storing the cooling water. The radiator 210 includes two tanks 214 at left and right ends of the radiator 210, and is of what is referred to as side flow type in which the cooling water for the engine flows in a left-right direction within the radiator tubes. Each of the tanks 214 has, on a side thereof, a fixing point for fixation to a body (for example, bulkhead) of the vehicle, and adopts a floating method in which the fixing point is attached to the body of the vehicle with a rubber mount or the like therebetween. The tanks 214 may be made from a high thermal conductive metal such as aluminum or a highly formable resin.

The condenser 220 cools a refrigerant of an air conditioner for the vehicle. The condenser 220 cools and liquefies the refrigerant that has been turned into a high-temperature, high-pressure gas by a compressor, not shown. As shown in FIG. 4, the condenser 220 has a condenser body 222 and a condenser tank 224. The condenser 220 has at least one condenser tank 224 at a side end thereof.

The condenser body 222 has a plurality of condenser tubes and a plurality of fins, not shown. The refrigerant is distributed and circulated inside the condenser tubes. The fins are provided in contact with outer surfaces of the respective condenser tubes to facilitate heat exchange between the refrigerant in the condenser tubes and cooling air. The condenser tank 224 separates gas and liquid in the refrigerant, and temporarily stores therein the refrigerant liquefied in the condenser bodv 222. The condenser also has a fixing point for fixation to the body (for example, bulkhead) of the vehicle, and adopts a floating method in which the fixing point is attached to the body of the vehicle with a rubber mount or the like therebetween.

The air barrier walls 230 are respectively provided on the two tanks 214 at the left and right ends of the radiator 210. Each of the air barrier walls 230 may be integral with the corresponding tank 214. For example, each tank 214 and the corresponding air barrier wall 230 may be formed as a single piece using a resin material or an aluminum alloy. As shown in FIG. 2, the air barrier walls 230 extend toward the condenser 220 while leaving a gap g between the air barrier walls 230 and the condenser 220. The gap g left between the air barrier walls 230 and the condenser 220 makes it possible to accommodate various layouts different in spacing between the radiator 210 and the condenser 220 without changing the size of the air barrier walls 230.

As shown in FIGS. 2 to 4, each of the air barrier walls 230 has a longitudinal wall section 232 extending toward the condenser 220, a lateral wall section 234 extending from an end of the longitudinal wall section 232 that faces the condenser 220 toward a neighboring one of the sides of the vehicle, and a second longitudinal wall section 236 extending from an end of the lateral wall section 234 that faces the vehicle's side toward the condenser 220. The cross section of the air barrier wall 230 shown in FIG. 2 is taken along plane B-B shown in FIG. 3 as a plane of section. As shown in FIG. 2, the cross sections of the longitudinal wall section 232 and the lateral wall section 234 of each air barrier wall 230 form an approximate L-shape, and the air barrier wall 230 is provided with a rib 238 inside the L-shape.

Preferably, each of the air barrier walls 230 extends from an upper end to a lower end of the corresponding tank 214 as shown in FIG. 3. This configuration increases the area of contact between the condenser 220 and air inside a space enclosed by the air barrier walls 230, allowing for an increased air cooling effect. Since the tanks 214 have the fixing points for fixation to the vehicle, the air barrier walls 230 provided on the tanks 214 allow the tanks 214 to have an increased rigidity. Thus, it is possible to prevent the tanks 214 from deforming due to the weight of the core 212 and the weight of the cooling water inside the tanks 214. Note that each of the air barrier walls 230 may be provided with a plurality of ribs 238 extending from an upper end to a lower end thereof. The ribs 238 provided on the air barrier walls 230 allow the air barrier walls 230 to have an increased rigidity. Thus, it is possible to prevent the air barrier walls 230 from deformi.no when the closure members 240 described below are respectively attached thereto, and it is possible to suppress vibration of the air barrier walls 230 resulting from, for example, the travel of the vehicle.

Preferably, each of the air barrier walls 230 on the tanks 214 is provided on a side toward the middle of the vehicle in the left-right direction as shown in FIGS. 2 and 4. For example, as for the tank 214 on a right side of the radiator 210 shown in FIG. 2, the air barrier wall 230 is preferably provided toward a left end of the tank 214. As for the tank 214 on a left side of the radiator 210 shown in FIG. 4, the air barrier wall 230 is preferably provided toward a right end of the tank 214. Although the traveling air cannot, pass through the tanks 214, arranging the air barrier walls 230 as described above allows the tanks 214 to be exposed to the outside of the air barrier walls 230 (toward the sides of the vehicle) to the greatest extent possible, enhancing the effect of cooling the tanks 214 using the traveling air eominc via the opposite ends of the radiator 210. Note that other components such as a harness and a temperature sensor can be disposed around the opposite ends of the radiator 210 by providing the air barrier walls 230 as close to the middle of the vehicle as possible.

As shown in FIG. 2, each of the closure members 240 is arranged along an inner side of a corner formed by the corresponding lateral wall section 234 and the corresponding second longitudinal wall section 236, and closes at least a portion of the gap g between the air barrier walls 230 and the condenser 220. The closure members 240 may be, for example, provided in a compressed manner between the air barrier walls 230 and the condenser 220 to close the gap g entirely. This configuration allows for reliable closure, and thus helps to enhance the effect of cooling the condenser 220 using air. Note that the closure members 240 may close the gap g almost entirely while leaving a small gap between the closure members 240 and the condenser 220. This configuration helps to prevent the closure members 240 from being worn out due to vibration of the radiator 210 and the condenser 220 resulting from, for example, the travel of the vehicle.

Examples of materials usable as the closure members 240 include rubber and rubber foam. For example, an ethylene propylene diene rubber (EPDM) foam sealing material may be used. The closure members 240 may be attached to the respective air barrier walls 230 using an adhesive.

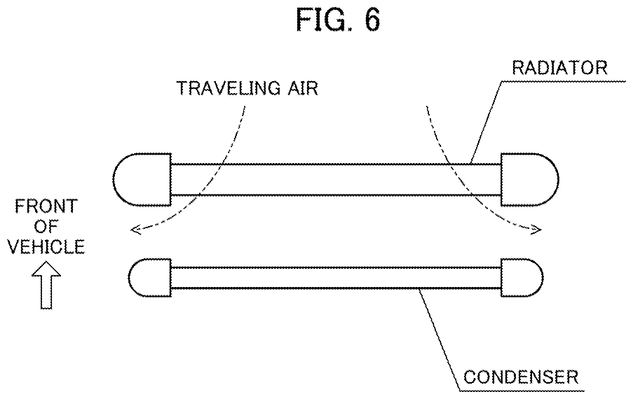

According to the present embodiment, the periphery of the space between the radiator 210 and the condenser 220 is closed using the closure members 240 and the air barrier walls 230 provided on the tanks 214 of the radiator 210. It is therefore possible to prevent the traveling air from escaping as shown in FIG. 6, so that the traveling air reliably comes into contact with the condenser 220 located behind the radiator 210, enhancing the cooling effect. It is also possible to prevent heat emitted from a heat generating element such as the engine from coming into the space between the radiator and the condenser through the gap to reduce the cooling efficiency.

In particular, since the air barrier walls 230 are provided and allow the closure members 240 to be each arranged along the inner side of the corner formed by the corresponding lateral wall section 234 and the corresponding second longitudinal wall section 236, it is possible to provide the closure members 240 in a simple and stable manner without the need to provide dedicated mounting parts. As a result, it is possible to reduce assembly man-hours as well as the vehicle cost. Furthermore, the second longitudinal wall sections 236 protect the closure members 240 from being largely exposed to the outside of the air barrier walls 230 (toward the sides of the vehicle). It is therefore possible to reduce damage to the closure members 240 due to hitting by stones and deterioration of the closure members 240 due to exposure to water.

Preferably, the condenser tank 224 of the condenser 220 is located further toward a neighboring one of the sides of the vehicle (left side in FIG. 4) than the neighboring air barrier wall 230 as shown in FIG. 4. Exposing the condenser tank 224 to the outside of the air barrier wall 230 (toward the vehicle's side) to the greatest extent possible enhances the effect of cooling the condenser tank 224 using the traveling air coming via the end of the radiator 210. Note that the ribs 238 provided on the air barrier wall 230 rectify the traveling air coining via the end of the radiator 210, further enhancing the effect of cooling the condenser tank 224.

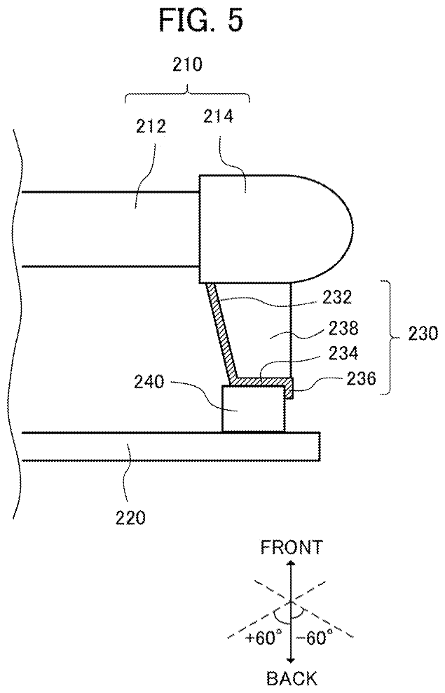

FIG. 5 is a plan view schematically illustrating a modification example of the foregoing embodiment. In the foregoing embodiment, the air barrier walls 230 have the longitudinal wall sections 232 extending in the front-back direction of the vehicle as shown in FIG. 2. However, the air barrier walls 230 according to the present invention are not limited as such. The longitudinal wall sections 232 of the air barrier walls 230 may be at an angle relative to the front-back direction of the vehicle as shown in FIG. 5. The angle may be, for example, determined depending on the size of the condenser 220 or the position of the condenser 220 relative to the radiator 210, and is preferably within ±60° relative to the front-back direction of the vehicle.

The foregoing embodiment is described using a condenser as an example of the heat exchanger disposed side by side with the radiator. However, the heat exchanger of the present invention is not limited to a condenser. The heat exchanger of the present invention encompasses other heat exchangers to be used for various purposes that can be disposed side by side with the radiator in the front-back direction of the vehicle. Examples thereof include: a heat exchanger to be used for the purpose of cooling oil of an engine, a transmission, or the like; and a heat exchanger to be used for the purpose of cooling an electrical component, such as a motor, a battery, a voltage converter, a power control, unit, or the like. Examples of such heat exchangers Include oil coolers, intercoolers, and sub-radiators.

Although the present invention has been described above using particular embodiments, the technical scope of the present invention is not limited to the scope of the embodiments described above. It would be obvious to those skilled in the art that various changes and modifications can be made to the embodiments described above. It would be obvious from the appended claims that the technical scope of the present invention can include embodiments involving such changes and modifications. For example, the particular embodiments are described in detail for better understanding of the present invention, but the present invention is not necessarily limited to those having all the described elements of configuration. Note that some of the elements of configuration of the embodiments can be omitted or replaced by other elements of configuration.

### EXPLANATION OF REFERENCE NUMERALS

100: Vehicle

102: Openin

104: Fan

200: Vehicle heat exchange apparatus

210: Radiator

212: Core

214: Tank

220: Condenser

222: Condenser body

224: Condenser tank

230: Air barrier wall

232: Longitudinal wall section

234: Lateral wall section

236: Second longitudinal wall section

238: Rib

240: Closure member

What is claimed is:

1. A vehicle heat exchange apparatus comprising:
a radiator having a core and tanks provided on left and right sides of the core;
a heat exchanger disposed side by side with the radiator in a front-back direction of a vehicle;
air barrier walls provided on the respective tanks, the air barrier walls extending toward the heat exchanger while leaving a gap between the air barrier walls and the heat exchanger; and
closure members each closing at least a portion of the gap.

2. The vehicle heat exchange apparatus according to claim 1, wherein
each of the air barrier walls has a longitudinal wall section extending toward the heat exchanger, a lateral wall section extending from a heat exchanger-facing end of the longitudinal wall section toward a neighboring one of the sides of the vehicle, and a second longitudinal wall section extending from a vehicle's side-facing end of the lateral wall section toward the heat exchanger, and
the closure members are provided on the respective air barrier walls and are each arranged along an inner side of a corner formed by the corresponding lateral wall section and the corresponding second longitudinal wall section.

3. The vehicle heat exchange apparatus according to claim 2, wherein
cross sections of the longitudinal wall section and the lateral wall section of each air barrier wall form an approximate L-shape, and the air barrier wall is provided with a rib inside the L-shape.

4. The vehicle heat exchange apparatus according to claim 1, wherein
the heat exchanger is a condenser having at least one condenser tank at a side end of the condenser,
the condenser is located behind the radiator in the vehicle, and
the condenser tank is located further toward a neighboring one of the sides of the vehicle than a neighboring one of the air barrier walls.

5. The vehicle heat exchange apparatus according to claim 1, wherein
each of the air barrier walls on the tanks is provided on a side toward the middle of the vehicle in a left-right direction of the vehicle and extends from an upper end to a lower end of the corresponding tank.
